(19) United States
(12) Patent Application Publication
(10) Pub. No.: US 2001/0047957 A1
(43) Pub. Date: Dec. 6, 2001

(54) WASTE TREATMENT SYSTEM

(76) Inventors: ANDREW ROBERT WINSTON GOUGH, ANNANDALE (AU); MARK KENNETH LANGFORD, TOWNSVILLE (AU); PAUL FREDERICK TURNER, TOWNSVILLE (AU)

Correspondence Address: AKIN, GUMP, STRAUSS, HAUER & FELD, L.L.P., ONE COMMERCE SQUARE, 2005 MARKET STREET, SUITE 2200, PHILADELPHIA, PA, 19103, US

(21) Appl. No.: 09/448,267

(22) Filed: Nov. 24, 1999

Related U.S. Application Data
(63) Continuation of application No. PCT/AU98/00393, filed on May 28, 1998.

(30) Foreign Application Priority Data
May 28, 1997 (AU) PO 7031

(51) Int. Cl. B01D 15/00

(52) U.S. Cl. 210/263

(57) ABSTRACT

Systems and apparatus are provided for treating waste-containing water such as toilet waste. In one aspect, an apparatus for secondary treatment of effluent from a water treatment process, includes a medium-filled tank adapted for gravity flow of the effluent through a plurality of discrete zones formed in the medium, wherein effluent flow through zones is alternately upward or downward. Further, a waste treatment system includes a primary tank for receiving undiluted waste and a medium-filled secondary tank for receiving gravity feed of effluent from the primary tank, wherein the secondary tank is adapted for gravity flow of the effluent through a plurality of discrete zones formed in the medium, and wherein effluent flow through zones is alternately upward or downward. Also, a waste treatment system includes a tank having a first zone and a plurality of discrete medium-filled secondary zones, wherein undiluted waste is received in the first zone and effluent therefrom flows under gravity through the secondary zones to exit the system with effluent flow through the secondary zones being alternately upward or downward.

### TECHNICAL FIELD

This invention relates to waste treatment systems and apparatus for use in such systems. In particular, the invention relates to a system and apparatus for treating toilet waste.

### BACKGROUND ART

Although municiple sewerage systems are widespread, there are many unsewered communities and areas for which alternative means must be relied on for disposal or treatment of toilet waste. This is particularly the case in rural areas of developed nations, and in some underdeveloped and developing nations.

Alternative means of disposal or treatment of toilet waste range from the mere burial of waste—with or without collection from dwellings—to septic systems which are common in many rural areas. However, these alternatives do have health risks as pathogens are invariably present in the waste, even in the effluent from a septic system.

There is an immediate need for effective waste treatment systems in some countries where faecal contamination of drinking water is a continual health problem. Because of the cost involved or the remoteness of a community, installation of a reticulated sewerage system may not be feasible. As well as the disadvantage of pathogen contaminated effluent, septic systems cannot be easily scaled up for community use, being primarily intended for use with single dwellings. The clarified effluent from septic systems can still be relatively rich in nutrients as well as bacteria and must be disposed of in a subterranean leaching fluid. This is not always practical in a community situation.

As septic systems can usually be installed with little difficulty and at comparatively little cost when compared with a sewerage system, it would be desirable to have a septic system which has reduced levels of contaminants in the system effluent and which can be scaled up for community use. It would also be desirable to have apparatus which could be used in conjunction with other waste water treatment processes—such as processes for the treatment of waste from piggeries, food processing plants including abattoirs, mine waste and the like—so that levels of contaminants in the ultimate effluent are reduced to acceptable levels with respect to environmental and public health requirements.

### SUMMARY OF THE INVENTION

The object of the invention is to provide a water treatment system which has reduced levels of contaminants in the system effluent and which, in the case of a septic system, can be scaled up for community use.

In a first aspect, the invention provides apparatus for secondary treatment of effluent from a water treatment process, said apparatus comprising a medium-filled tank adapted for gravity flow of said effluent through a plurality of discrete zones formed in said medium, wherein effluent flow through zones is alternately upward or downward.

In a second aspect, the invention provides a waste treatment system comprising a primary tank for receiving undiluted waste and a medium-filled secondary tank for receiving gravity feed of effluent from said primary tank, wherein said secondary tank is adapted for gravity flow of said effluent through a plurality of discrete zones formed in said medium, and wherein effluent flow through zones is alternately upward or downward.

In a third aspect, the invention provides a waste treatment system comprising a tank having a first zone and a plurality of discrete medium-filled secondary zones, wherein undiluted waste is received in said first zone and effluent therefrom flows under gravity through said secondary zones to exit said system with effluent flow through said secondary zones being alternately upward or downward.

The term “water treatment process” used above denotes any process intended to reduce the level of contaminants in waste-containing water be it industrial or domestic waste, or toilet waste. Such treatment processes include, but are not restricted to, processes for treating piggery waste, food processing plant waste, grey water (bath, shower, kitchen and laundry waste water) and potable water.

The tank of apparatus according to the first aspect, which, it will be appreciated, is the secondary tank of the system according to the second aspect, acts as a biological filter and is analogous to the subsurface flow constructed wetlands of wastewater treatment systems. As downward and upward flow occurs in the discret zones, the effluent encounters anaerobic and aerobic zones so improving the treatment process.

The secondary tank can be of any shape but is preferably of circular cross section with a slightly domed top which includes an inlet for the primary tank effluent. The discrete zones are advantageously provided as coaxial chambers within the tank. Effluent can flow from the top of a zone to the adjacent zone by merely flowing across the open end of the wall forming a chamber. Openings are provided in a portion at the bottom of a chamber to permit flow of effluent from the bottom of a zone to the adjacent zone. This will be explained in greater detail below.

In a preferred form of the secondary tank, four concentric zones are provided with the tank inlet feeding the innermost zone. However, it will be appreciated that flow can be from the outermost to the innermost zone.

The medium used to fill the secondary tank can be any granular material such as gravel, sand or aggregated soil. However, the size of the particles of granular material should be sufficient to give a void size which does not impact adversely on detention time or can be blocked with biofilm. Synthetic materials, such as a plastics material, can also be used as the medium. A preferred medium is a plastics medium comprising sections of tubing having a diameter of 15 to 30 mm and a length of 20 to 50 mm.

Apparatus according to the first aspect of the invention can be incorporated into any existing septic system. Hence, in the system according to the second aspect, the primary tank can be a conventional septic tank. Advantageously, effluent from the secondary tank, appropriately disinfected, is used for flushing in a system where flushing of the toilet is desired. With effluent recycle, little or no additional water is required.

The system according to the invention does not require flushing of toilet waste into the primary tank. Indeed, an advantage of the system is that there is no liquid requirement beyond that provided as waste which consequently reduces the volume of effluent from the secondary tank.

The ratio of the volume of the primary tank to the volume of the secondary tank typically falls within the range of 1:1 to 1:0.6. Factors to be taken into account when configuring a system, particularly for community use, are the diet and excreta volumes of the users, and the number of toilets per person available for input waste to the system.

The secondary tank of a system according to the second embodiment typically includes from 3 to 8 zones. In a preferred secondary tank, four zones are provided. Zones need not necessarily be of equal volume and in a preferred form of the secondary tank—which is a circular tank—with four zones, zones increase, in the order of effluent passage, from 8 to 18% of the volume of the tank for the initial zone to 24 to 50% of the tank volume for the final zone.

The primary tank of a system according to the second aspect typically has a detention time of 40 to 150 days.

The detention time of the secondary tank is typically greater than 25 days depending on evaporation rates which will be influenced by the climatic conditions of the area where the system is located.

The tanks of apparatus according to the first aspect and the system according to the second aspect can be fabricated from any suitable material such as a plastics material, fibreglass or concrete. A preferred material is polypropylene.

At start up of a new installation, the primary tank of a system according to the second aspect is charged with water to about 50% of capacity. With usage, the primary tank fills to the extent that clarified effluent flows from the primary tank via a conduit to the secondary tank. Alternatively, the primary tank can be filled to 100% capacity at start up. The bacteria in the primary tank ultimately form a sludge as in any septic tank. In the system according to the invention, sludge pump out will typically be required every five to ten years depending on unit design.

To improve airflow in the secondary tank, a vent can be provided which includes a fan which draws or forces air into the tank. The air supply increases evaporation, supplies oxygen to the surface of the medium in the secondary tank, and vents odours from the system. In remote locations with no power supply, the fan is advantageously solar powered. The vent can alternatively be provided at the primary tank. In this configuration, air is drawn from a port in the secondary tank.

In one form of the system according to the second aspect, the primary and secondary tanks are provided as a single unit. For example, the secondary tank can be contained within the primary tank. With tanks of circular cross-section, the primary tank essentially takes the form of a chamber concentrically disposed about the secondary tank. In such a configuration, flow through the zones of the secondary tank will usually be from an outer zone to an inner zone from which effluent exits the system.

The system according to the third aspect is, in essence, the single unit described in the previous paragraph. However, in the system of the third aspect, the secondary zones rather than being provided as chambers formed within the secondary tank, are typically present as individual secondary tanks within the tank containing the system. This will be explained in greater detail below.

The medium used for the zones of the system according to the third aspect can be the same medium described above. Similarly, system components can be manufactured from the same materials as components of other aspects and the system can include the optional features and preferments of the system according to the second aspect.

Systems according to the third aspect of the invention are particularly suited as toilet systems for daily use by about five people while systems according to the second aspect can be sized for use by from about ten to in excess of 500 people. Systems can also be constructed in a modular format by including multiple primary and/or secondary tanks connected in parallel. Systems can be included within an existing dwelling—with appropriate excavation if necessary as a system must be below floor level—or in a purpose-built structure which is usually the case with systems intended for communal use.

A toilet pedestal or the like is typical provided in conjunction with systems from which waste passes via a drop-tube to the primary tank of the second aspect or the tank of the third aspect. Drop-tubes can include deflectors—these being spaced-apart downwardly angled panels projecting from opposite sides of the drop-tube—so that waste in the tank cannot be viewed via the pedestal.

The primary tank of a system according to the second aspect and the tank of the third aspect, can include baffles for the separation and direction of processed waste (sludge) to removal points in tanks. Sludge removal is typical required every five to ten years.

It will be appreciated that single unit forms of systems according to the invention reduces the area taken up by the systems. This is advantageous in situations where the system is for commercial use.

The closed nature of systems according to the invention protects the systems from external elements such as sun and rain. Furthermore, ground water and root intrusion is prevented while on the other hand ground water quality is protected. Insects such as mosquitoes are also excluded. As noted above, flush water is not required which minimises the final effluent from systems. This effluent is sufficiently low in biochemical oxygen demand (BOD) and bacteria—typically 12 mg/l and 0.62 organisms/ml, respectively—that it can be used for irrigation or merely run to waste. Usually, final effluent is disposed of via a subterranean gravel bed.

The invention includes within its scope toilets comprising systems according to the second or third aspects, and methods of treating waste—particularly toilet waste—using the disclosed systems.

Having broadly described the systems and apparatus, systems will now be exemplified with reference to the accompanying drawings briefly described hereafter.

### BRIEF DESCRIPTION OR THE DRAWINGS

FIG. 1 is a schematic representation of a system according to the second aspect of the invention.

FIG. 2 is an elevational view in cross-section of the secondary tank of the system shown in FIG. 1.

FIG. 3 is a plan view in cross section of the secondary tank shown in FIG. 2.

FIGS. 4 to 6 are elevational views in cross-section to the same scale of the members which form the zones in the secondary tank shown in FIGS. 2 and 3.

FIG. 7 is an elevational view in cross-section of an alternative type of secondary tank.

FIG. 8 is an exploded perspective view of the major components of a system according to the third aspect of the invention.

FIG. 9 is a plan view of a system according to the third aspect with the top of the tank removed.

FIG. 10 is an elevation view at section A-A of FIG. 7.

FIG. 11 is an elevational view at section B-B of FIG. 7.

### BEST MODE AND OTHER MODES FOR CARRYING OUT THE INVENTION

Like items in different drawings are indicated by the same reference numeral.

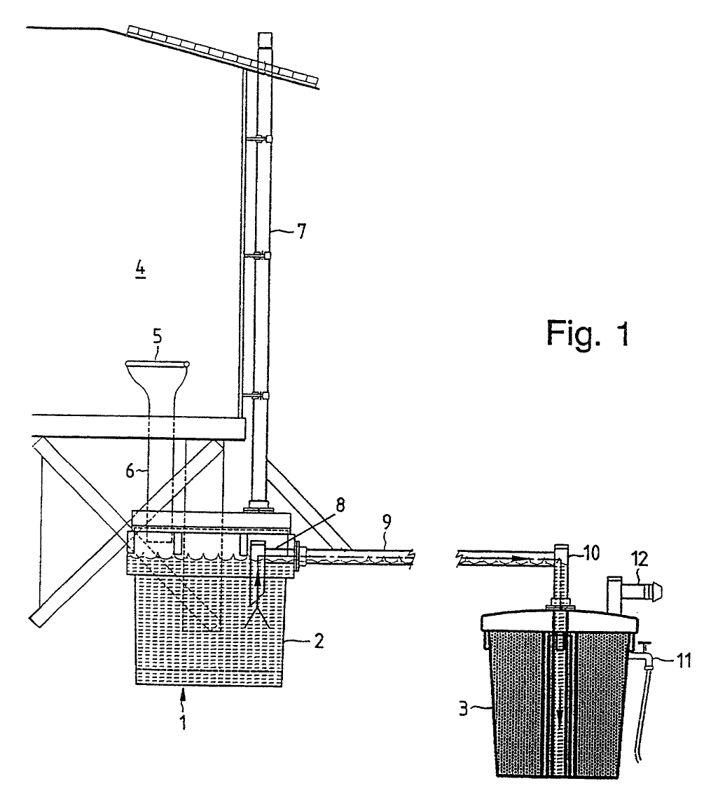

Turning now to FIG. 1, there is shown system 1 comprising a primary tank 2 and a secondary tank 3. Primary tank 2 is beneath a toilet 4 and receives waste from a pedestal 5 having an extended outlet 6. The extended outlet is not essential and the pedestal can be mounted immediately above tank 2. The only constraint on the configuration is that there be gravity flow from tank 2 to tank 3. Primary tank 3 also includes a vent 7 and a baffled outlet 8 as is usual in septic tanks.

Effluent from primary tank 2 flows under gravity via conduit 9 to secondary tank 3 via inlet 10 which is centrally positioned on the top of the tank. Secondary tank 3 also includes an outlet 11 and vent 12 which has associated therewith a solar powered fan (not shown in the drawing).

Primary tank 2 has a capacity of about 1,000 l while secondary tank 3 has a capacity of about 600 l. Interconnecting conduit 9 is 100 mm diameter PVC piping. Primary tank 2 is of circular cross-section with slightly tapering sides. Secondary tank 3 is charged with gravel of 10 to 15 mm size as generally indicated by the stippling.

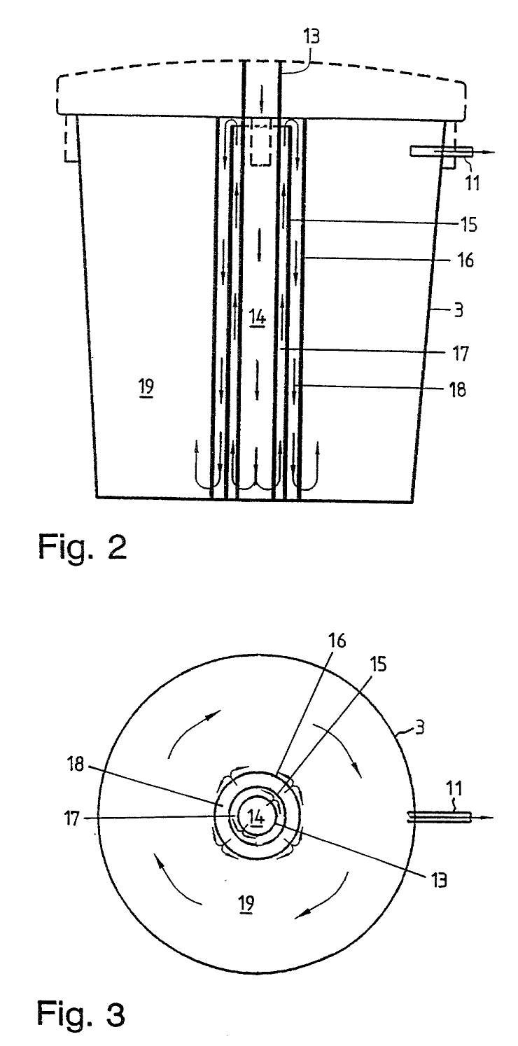

Secondary tank 3 is shown in greater detail in FIGS. 2 and 3. Inlet 10 (see FIG. 1) is contiguous with cylindrical member 13 which forms zone 14 in the tank. Cylindrical members 15 and 16 demark zones 17 and 18 while the wall of the tank demarks zone 19. It can be appreciated from the figures that incoming fluid flows down through zone 14 then to zone 17 where it flows upwardly to enter zone 18, downwardly again to enter zone 19 from where it can ultimately exit the system via outlet 11. The flow is generally indicated by the arrows. FIG. 3 also shows the circular flow which can occur in the tank. Although not indicated in these figures, all zones of the tank are charged with gravel. The effluent course through the tank has an overall length of 5.0 to 5.5 m.

It will be appreciated from the foregoing paragraph that flow through secondary tank 3 is a mixture of upward and downward and rotational. This is an advantage over symmetric chambers in which there is no rotational flow. The rotational flow extends the flow contact length and time within the system.

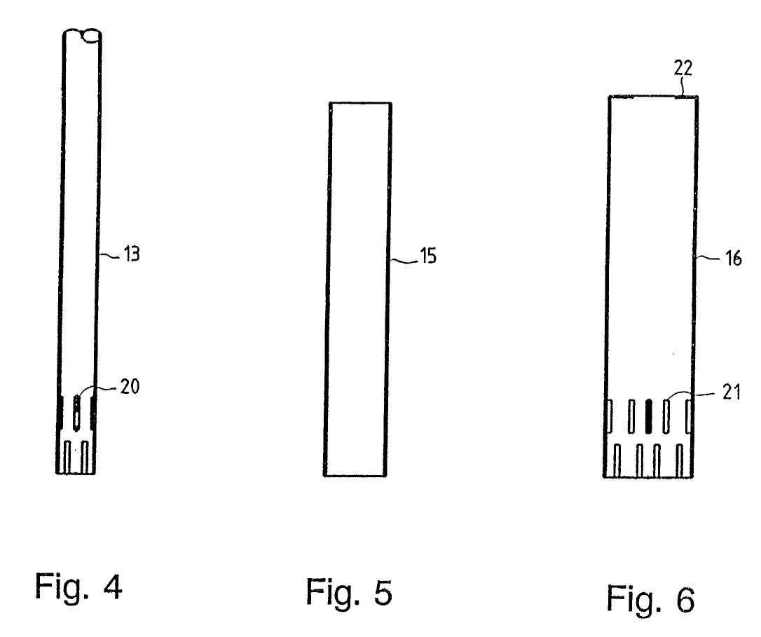

Enlarged views of each of members 13, 15 and 16 are shown in FIGS. 4 to 6, respectively. Member 13 (FIG. 4) is 100 mm diameter PVC pipe which extends from the tank cover to the floor. Slots of about 10 mm wide by about 80 mm long are provided in the bottom of the member to allow egress of fluid. One such slot is indicated at 20.

Member 15 (see FIG. 5) extends from the floor of the tank to just below the upper end of member 16. Member 15 thus in effect acts as a stand pipe. The member is fabricated from 300 mm diameter pipe.

Member 16 (see FIG. 6) is fabricated from 500 mm pipe and like member 13 has a plurality of slots at the bottom thereof, one of which is indicated at 21. The top end of member 16 includes a wall 22 which extends across to member 13 when the members are in situ. This wall prevents short circuiting of fluid.

The system and components thereof depicted in FIGS. 1 to 6 was configured for use with a dwelling occupied by up to 10 people. At start up, the primary tank was charged with 900 l of water (100% capacity). The secondary tank was similarly filled with water to capacity.

The system was monitored over a period of 4 months allowing the performance figures given hereafter to be established.

| | |
|---|---|
| Primary tank | |
| Volume of contents | 900 l |
| Detention time | 75 days |
| Biochemical oxygen demand (BOD) of effluent | 192 mg/l |
| Nitrogen fixation rate | |
| (NFR) of effluent | 170 mg/l |
| E. coli in input waste | 10,000/ml |
| E. coli in effluent | 540/ml |
| Secondary tank | |
| Volume of contents | 300 l |
| Detention time | >25 days |
| BOD in effluent | 12 mg/l |
| NFR | 13 mg/l |
| E. coli in input waste | 540/ml |
| E. coli in effluent | 0.62/ml |
| Total effluent detention | 100 days |

The BOD, NFR and E. coli levels in the secondary tank effluent can be seen to be an appreciable improvement over the same values for the primary tank effluent and hence over the effluent from a conventional septic tank system.

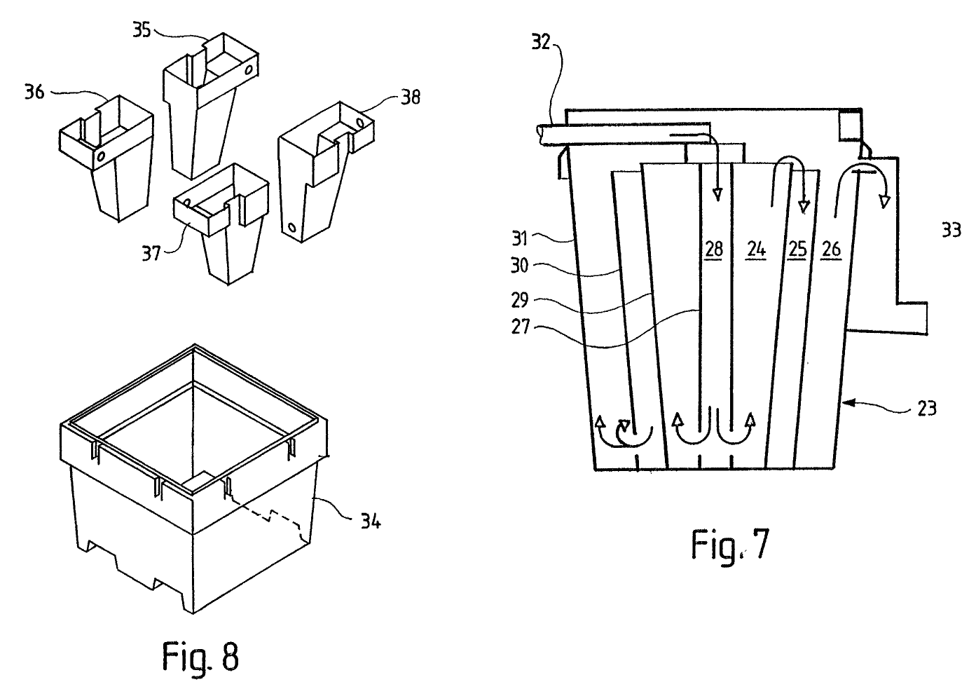

With reference to FIG. 7, there is shown an alternative secondary tank for use in a system such as depicted in FIGS. 1 to 6. FIG. 7 shows tank 23 which is of circular cross-section and is formed from an inverted frustum of a cone. The tank has three zones, 24 to 26, formed, respectively, by cylindrical wall 27 of a drop-tube 28, frusto-conical walls 29 and 30, and the wall 31 of the tank. Effluent from a primary tank enters tank 23 from pipe 32 function box 33. Drop tube 28 has a plurality of openings at the bottom thereof which allows effluent to enter zone 24 as shown by the arrows. Walls 29 and 30 have single openings which allows effluent to flow to the adjacent zone as again shown by the arrows.

Tank 23 and other components are manufactured from polyethylene. The tank has a capacity of 630 l. Zones 24 to 26 are filled with 10 mm graded rock and comprise, respectively, 18%, 24% and 50% of the tank volume. Alternatively, the medium can be the preferred plastics material described above.

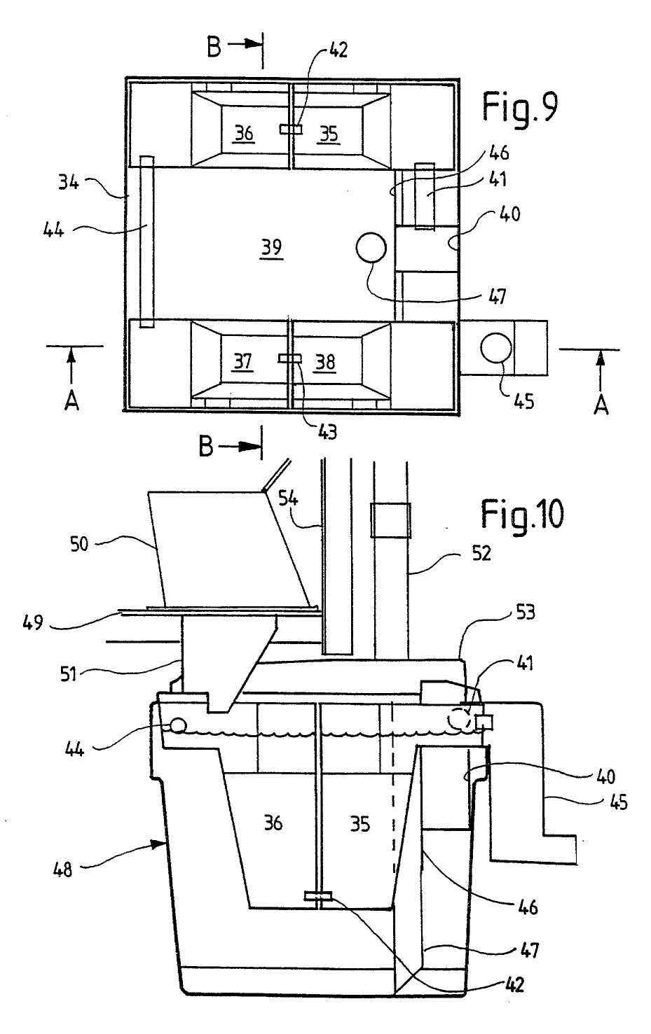

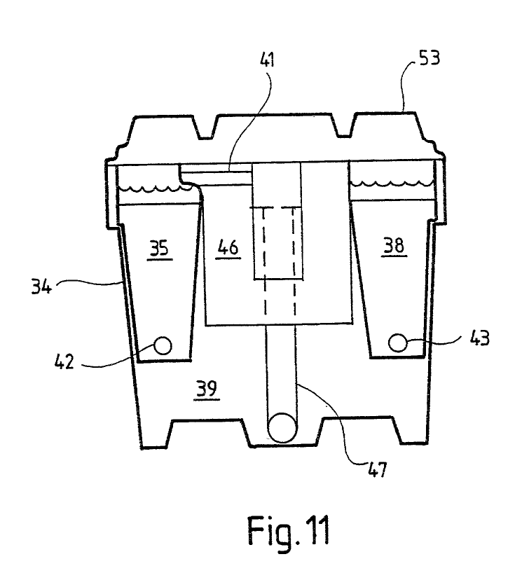

FIGS. 8 to 11 show a system according to the third aspect of the invention. The system forms part of a toilet as can be appreciated from FIG. 10. The system comprises a tank 34 and four secondary tanks, 35 to 38. The secondary tanks form the secondary zones while the balance of the volume of tank 34 with the secondary tanks in situ forms the first zone, item 39 of FIGS. 9 to 11.

Referring now to FIGS. 9 to 11, the system can be seen to further include a junction box 40 which is connected to secondary tank 35 by pipe 41. Secondary tanks 35 and 36 are in fluid communication via connector 42 near the bottom of each tank as are secondary tanks 37 and 38 via connector 43. Secondary tanks 36 and 37 are in fluid communication via pipe 44. Effluent in secondary tank 38 can exit the system via outlet 45 which is in fluid communication with the secondary tank. The system further includes a baffle plate 46 and a sludge drawoff pipe 47.

Features of the toilet system as a whole can be appreciated from FIG. 10 which in addition to the features included in other figures shows system 48 as described above in connection with FIGS. 8 to 11 installed beneath the floor 49 of a dwelling or other construction. Waste passes from toilet pedestal 50 via drop-tube 51 into first zone 39. System 48 also includes a vent pipe 52 extending from cover 53 of tank 34. The vent includes a solar powered fan, not shown in the figure, which draws air through the system from a port in tank 34 to exit the system via the vent. Item 54 is a wall of the construction housing the toilet system.

Secondary tanks 35 to 38 are filled with a plastics medium of roughly cylindrical objects having an average diameter of 19 mm and an average length of 30 mm. The major components of the system, tank 34 and secondary tanks 35 to 38, are fabricated from polyethylene. Other components are fabricated from a plastics material or stainless steel.

Tank 34 has a capacity of 770 l while secondary tanks 35 to 38 have a total volume of 160 l. The detention time of tank 34 is 53 to 128 days while secondary tanks 35 to 38 have a detention time of 26 days.

Flow of liquid effluent through system 48 is as follows. Waste builds up in first zone 39 of tank 34 such that liquid can enter secondary tank 35 via junction box 40 and pipe 41. Liquid effluent then flows downward through the medium in secondary tank 35 through connector 42 to secondary tank 36, upward through the medium in secondary tank 36 to secondary tank 37 via pipe 44, downward through the medium in secondary tank 37 to secondary tank 38 via connector 43, then finally upward through the medium in secondary tank 38 to exit the system at outlet 45.

It will be appreciated that many changes can be made to the systems and apparatus as exemplified above without departing from the broad ambit and scope of the invention.

1. Apparatus for secondary treatment of effluent from a septic tank, said apparatus comprising a medium-filled circular tank adapted for gravity flow of said effluent through at least three discrete zones formed by coaxial chambers of circular cross-section within said tank, wherein effluent flow through zones is alternately upward or downward and rotationally within a zone, and wherein said medium comprises a granular material or a tubular material.

2. Apparatus according to claim 1, wherein flow of effluent is from an inner zone to an outer zone.

3. Apparatus according to claim 1, wherein said granular material is selected from gravel, sand, aggregated soil or a synthetic material.

4. Apparatus according to claim 1 comprising four zones.

5. A waste treatment system comprising a primary tank for receiving undiluted waste and a medium-filled secondary tank for receiving gravity feed of effluent from said primary tank, wherein said secondary tank is a covered circular tank adapted for gravity flow of said effluent through at least three discrete zones formed by coaxial chambers of circular cross-section within said tank, wherein effluent flow through zones is alternately upward or downward and rotationally within a zone, and wherein said medium comprises a granular material or a tubular material.

6. System according to claim 5, wherein flow of effluent in said secondary tank is from an inner zone to an outer zone.

7. System according to claim 5, wherein said granular material is selected from gravel, sand, aggregated soil or a synthetic material.

8. System according to claim 5, wherein said tubular material is a plastics material having a diameter of 15 to 30 mm and a length of 20 to 50 mm.

9. System according to claim 5, wherein said secondary tank comprises four zones

10. System according to claim 5, wherein effluent from said secondary tank is recycled for flushing of toilet waste into said primary tank.

11. System according to claim 5, wherein the ratio of the volume of said primary tank to the volume of said secondary tank is within the range of 1:1 to 1:0.6

12. System according to claim 5, wherein said primary tank includes a vent having a fan which draws air into said system via a port in said secondary tank.

13. System according to claim 5, wherein said secondary tank is included in said primary tank.

14. A waste treatment system comprising a primary tank which contains a plurality of medium-filled secondary tanks, the volume of the primary tank not occupied by the secondary tanks forming a first zone and said secondary tanks comprising secondary zones, wherein undiluted waste is received in said first zone and effluent therefrom flows under gravity through said secondary zones to exit said system with effluent flow through said secondary zones being alternately upward or downward.

15. System according to claim 14, wherein said primary tank is generally rectangular and contains four secondary tanks of generally rectangular cross-section.

16. System according to claim 15, wherein said secondary tanks are arranged as pairs at opposite sides of said tank.

17. System according to claim 14, wherein said medium is selected from gravel, sand, aggregated soil or a synthetic material.

18. System according to claim 17, wherein said synthetic material is a plastics material.

19. System according to claim 18, wherein said plastics material comprises sections of tubing having a diameter of 15 to 30 mm and a length of 20 to 50 mm.

20. System according to claim 14, wherein the ratio of the volume of said primary zone to the total volume of said secondary zones is in the range of 1:1 to 1:0.4.

21. System according to claim 14, wherein said tank includes a vent having a fan which draws air into said system via a port in said tank.

22. System according to claim 14, wherein said tank includes a tube for withdrawal of settled sludge.

23. A toilet comprising the system according to claim 5 or claim 14.
